(19) United States
(12) Patent Application Publication
(10) Pub. No.: US 2013/0047910 A1
(43) Pub. Date: Feb. 28, 2013

(54) STERN SEGMENTS THAT CAN BE LOWERED FOR A WATER VEHICLE

(71) Applicant: Peter A. Mueller, Gattikon (CH)

(72) Inventor: Peter A. Mueller, Gattikon (CH)

(21) Appl. No.: 13/579,395

(22) PCT Filed: Feb. 15, 2011
(86) PCT No.: PCT/CH2011/000030

§ 371 Date: Nov. 5, 2012

(30) Foreign Application Priority Data
Feb. 16, 2010 (CH) 190/10

(51) Int. Cl. B63B 27/14; G06F 19/00

(52) U.S. Cl. 114/362; 114/343; 701/21

(57) ABSTRACT

The invention relates to a folding frame (1) which is foldable and or adjustable in height and or displaceable in the longitudinal direction and has adjustable step means (16) and these remain positionally stable when the folding frame (1) is unfolded and if necessary a gas spring (65) coupled with a pressureless switch (64) or quick release means (68) can raise the folding frame (1) at any time. The folding frame (1) optionally has a cover (53) and the step means (16) have rail elements (21), wherein the corresponding folding and displacement of a tender on the folding frame (1) takes place by means of sensors and a controller (18). The folding frame (1) has a rotating folding frame (38) that can be offset and optionally a telescoping gangway (41).

### TECHNICAL FIELD

The invention relates to a swing frame, which can be unfolded and lowered, attached to the stern of a watercraft with segmented elements attached thereto which cover different functions with the same means, such as is used, e.g. as a component of a vehicle base or as a stern cockpit cover or as a bathing platform or as stairs or is used as a means for lowering onto water or raising a tender and other technical products, according to the preamble of the first claim.

### PRIOR ART

Lowerable platforms, specifically for swimmers, divers and for tender vehicles, are known, as described in patents DE 196 02 331, U.S. Pat. No. 6,327,992, U.S. Pat. No. 5,690,045. These allow persons or material to be conveniently lowered to water or to be taken on board.

Likewise, foldout stern parts are known, which serve as a bathing platform or as a carrier for raising or lowering tenders out of or into water.

In the case of yachts, extendible ladders from the hull or from the swim platform are known, as described, e.g. in U.S. Pat. No. 6,789,648 B2 or parts of the swim platform are lowered into the water in an arc, on which parts step elements are located, as described in U.S. Pat. No. 7,121,226 B2.

### DESCRIPTION OF THE INVENTION

The object of the invention is, on a water craft, by means of segmented elements that can be changed into a stern-side cockpit cover or a base plate or a railing or a bathing platform or into a gangway or stairs and optionally into a tender lift, in that the segmented elements can be folded and/or lowered accordingly and the segmented elements exist in the form of pivoted and rotatable elements.

The stern region has always been the central meeting place for leisure watercraft users. Nevertheless, the walk from the cockpit, i.e. from the interior of a watercraft as a protected area, to the water was and is an unsatisfactory act which has been solved satisfactorily to some extent only by small door openings and a bathing platform possibly projecting behind the watercraft stern and a ladder. The invention is designed to considerably simplify and improve this walk to the water and back by means of a multifunctional system, which is actuated in a power operated and or spring-loaded manner.

The multifunctional system has a torsionally stiff folding frame with plate segments, which are pivoted on the folding frame 1 and serve as step elements as well as a cover. A system of this type can thus be used, e.g., as a base element or, when partially hinged up without thereby adjusting the step elements, can serve as a cockpit cover or as a railing or by means of the adjustment of the step elements into a horizontal position, the system lends itself as a gangway aid and with a further retention of the horizontal position of the step elements and with a further folding of the folding frame, finally represents a bathing platform and, with further swiveling of the folding frame, is used as convenient stairs. Likewise, to increase convenience and for safety aspects, a cover can be attached by means of spacers on the outboard side, wherein the cover can be light-permeable and thus the adjustable step elements in the cockpit cover take over the function of blinds in that in the horizontal position they make a view of the water possible, in the vertical position they prevent a view into the cockpit.

Rail elements on the folding frame or additional supports or on the step elements make it possible in the horizontal position of the step elements to likewise shift a tender from a fixed platform or garage onto the segmented step elements and to lower or lift the tender accordingly by means of the lowering device. A horizontal shifting option of the entire folding mechanism makes it possible to accommodate tenders of different sizes with one and the same system.

The function of the gangway is a popular attribute in Europe for reaching land easily and therefore an integrated, telescoping gangway on the folding frame is in particular an advantage since the folding infrastructure is already available. Instead of as usual using an active cylinder in order to extend a gangway, according to the invention a compact solution was chosen in that a rack and pinion system allows the gangway to be displaced longitudinally. An additional smaller folding frame can be attached to the folding frame by means of hinges, so that the smaller folding frame, e.g. rotated by 90° and locked, becomes a handrail.

The folding operation can be carried out in a power operated manner by means of fluid force or electrically or manually. In the manual version, the folding frame is held in balance with the step elements by means of a mechanical spring or gas spring, or the exertion of force during folding is also reduced and the gas spring is used in the power operated version for guiding back the folding frame into the upper, simultaneously standard position. By means of pressureless switching of the hydraulic pressure and targeted discharge of the fluid back into the tank or emergency disconnection of the active cylinder from the swiveling mechanism and by means of possibly lockable gas springs, a convenient and safe solution for raising the folding frame with its positionally constant stair steps can be ensured.

According to the invention, this is achieved by the features of the first claim.

The basic point of the invention is, by means of a foldable or lowerable folding frame with a corresponding drive for the folding and one for the lowering with rotatable step elements with a further independently guided drive, to render possible a cockpit cover or as a base plate, or bathing platform plate, gangway, stairs and a tender guide with one and the same device, with a light-permeable cover to further render possible the view of the water at the same time and to thereby keep wind and waves away from the cockpit.

The term folding frame also stands for the term railing.

Further advantageous embodiments of the invention are shown by the subordinate clams.

### BRIEF DESCRIPTION OF THE DRAWINGS

Exemplary embodiments of the invention are explained in more detail below based on the drawings. Identical elements are provided with the same reference numbers in the different figures.

They show

FIG. 1 a diagrammatic side view of a swiveling folding frame with rotatable step elements, a worm drive with an angle blocking means, an angular sensor, damping means as well as a pressure relief spring and a solar angle of incidence sensor

FIG. 2 a diagrammatic side view of a swiveling folding frame with rotatable step elements with rail elements, as well as the swiveling folding frame is attached to a horizontally displaceable and lowerable plate with active cylinder and a position sensor

FIG. 3 a diagrammatic stern view of a swiveling folding frame with rotatable step elements, which is attached to a swiveling mechanism with a pipe connection and laterally to hinges, small folding frames are attached with extendible handrail and a telescoping gangway

FIG. 4 a diagrammatic side view of an extendable and swiveling gangway, attached to a folding frame in a pivoted and lockable manner and on which in addition a cover is located with spacers.

FIG. 5 a diagrammatic side view of a swiveling means with a fluid cylinder, with pressureless switch, stop valve, and a gas spring with an unlocking valve.

Only the elements essential for directly understanding the invention are shown diagrammatically.

### WAY OF CARRYING OUT THE INVENTION

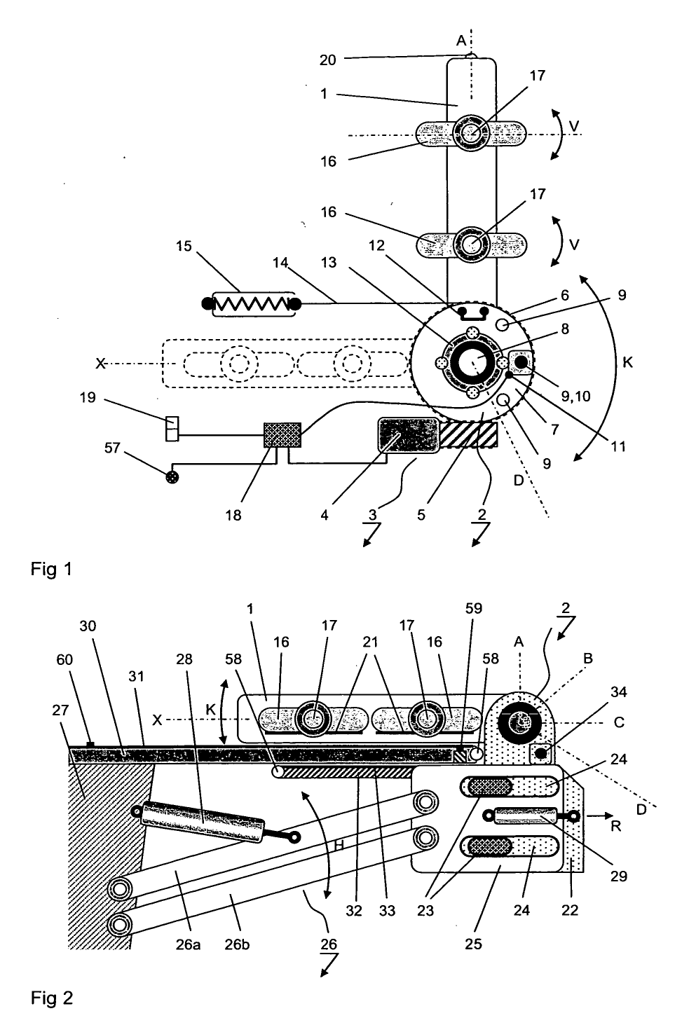

FIG. 1 shows a diagrammatic side view of a swiveling folding frame 1, which can be folded by means of a swiveling means 2 according to arrow K. The swiveling means 2 is driven by means of a rotation active means 3, composed of a motor 4 and a transmission 5, here indicated by a worm, which acts on the gear wheel 6, which is connected to the turntable 7. The turntable 7 contains the slewing journal 8 with its bearing, the blocking recesses 9, the blocking means 10 and the angular sensor 11, as well as the freewheel mechanism 12 and the damping 13.

A traction means 14 is attached to the turntable 7, which traction means is connected to a helical tension spring 15. Furthermore, the folding frame 1 is attached to the turntable 7, which folding frame has step means 16 and these are adjustable by means of the bearing 17, according to arrow V. The swiveling operation is controlled by means of the controller 18 and triggered by means of the button 19, provided that the collision sensor 57 permits the operation. An automatic adjustment of the step means 16 can be carried out by means of an incidence of light sensor 20.

Access to the water or on land or the enlargement of the stern area of a watercraft as well as the possibility of the protective cover of the cockpit region can be ensured in an elegant and cost-effective manner by the corresponding design of the folding frame 1. The embodiment shown here makes it possible to unfold a torsionally stiff folding frame 1, which is attached to the stern or to the bathing platform of a watercraft, from a horizontal position X via the folding path K to the position D, which represents a step. The respective intermediate angle positions can be used as a cockpit cover or as a gangway or as a bathing platform. The swiveling means 2, which is accommodated in a waterproof housing (not shown here) with corresponding bearings, is either directly attached to the stern of the vehicle or to an existing bathing platform or tender platform and in the power controlled version with the rotation active means 3, shown here as a worm gear—a planetary gear or a cycloid gear is also conceivable—which has an angular sensor 11 and a controller 18, which ensures a) that the user of the system knows whether the folding frame 1 is correctly retracted, otherwise the watercraft may not and cannot reach its full speed, b) a position of the folding frame 1 once triggered is to be maintained, otherwise the controller 18 issues the command accordingly to correct to the desired value again. Furthermore, the swiveling means 2 has a turntable 7 which has corresponding blocking recesses 9, which e.g. in the form of a ratchet or as shown here by means of a perforated disk and the blocking recesses 9 represent bores in the turntable 7, wherein both variants have a blocking means 10 that can be a spring-loaded lifting magnet and by means of the engagement of a bolt into the blocking recess 9, the swiveling means 2 is stopped. This technical solution is an advantage even in connection with the use of a self-locking worm, since erratic high compressive loads on the transmission 5, triggered by persons moving on the step means 16, e.g., in the bathing platform position, can be accordingly highly impact acting. Furthermore, the swiveling means 2 can be elastically supported with respect to the folding frame 1, by means of a damping 13 in the form of a rubber bearing or viscous damper. Only a one-sided damping is advantageous, which suggests itself anyway, should the blocking means 10 engage in a narrow bore on the turntable 7 and thus there is no spring deflection, in the case that the folding frame 1 would collide with an object lying outside the vehicle, which could thus lead to a high load on the stern structure of the vehicle or swiveling means 2.

The unfolding of the folding frame 1 is easy due to the force of gravity and thus the motor 4 is not loaded, but must even act as a brake. In contrast, the same motor 4 is heavily loaded when the folding frame 1 is lifted because this it to lift the total weight of the folding frame 1 and the step means 16. This asymmetrical exertion of force can be reduced accordingly by means of a helical tension spring 15, which is attached to the turntable 7 by means of a traction means 14. The helical tension spring 15 can be a mechanical spring or a gas compression spring or gas tension spring or, somewhat more complex, a hydraulic active cylinder, e.g. with only an accumulator or electrical active cylinder as auxiliary drive. The helical tension spring 15 can also represent a spiral spring, which can be built in between the swiveling means 2 and the housing, not shown here.

In the version in which the folding path K of the folding frame 1 takes place manually with the aid of a helical tension spring 15 and traction means 14, in that the extension takes place with manual force against the helical tension spring 15 and finally is manually locked in the desired position by means of a manual catch lock, the lifting is then carried out by the force of the helical tension spring 15. The use of a gas pressure cylinder or gas tension cylinder lockable depending on the installation position is more convenient. The extension of the folding frame 1 in turn is carried out by means of manual force against the gas pressure, holding in a desired position, however, is caused by means of locking the gas column or oil column in the interior of the gas pressure cylinder or gas tension cylinder. The folding frame 1 is raised with gas pressure by means of opening the locking valve in the gas cylinder. A locking means 10 is thus not absolutely necessary.

In order not to keep the stroke of the helical tension spring 15 too long with a large folding path K, the folding frame 1 can be uncoupled from the swiveling means 2 by means of a freewheel mechanism 12 in that a decoupling lever, not shown here, is actuated. Thus e.g. the folding frame 1 without great exertion of force can be deposited in position X and lifted again into position A and there in turn coupled to the swiveling means 2.

Furthermore, the step means 16 is located on the folding frame 1, which step means are attached in the form of adjustable step elements with bearing 17 to the folding frame 1. The adjustment mechanism of the adjustable step elements is not explicitly shown which can be separately force controlled or can be adjusted by electric motor by means of the controller 18 and controlled by the corresponding software. The step means 16 can thus also be individually adjusted also independently of the folding frame 1.

If the step means 16 in addition are equipped with solar panels an incidence of light sensor 20 attached to the watercraft or to the folding frame 1 can help the step means 16 to track the position of the sun and thus help to improve the yield of solar energy in the on-board power supply of the watercraft.

Furthermore, it is useful to integrate a collision sensor 57, which likewise is connected to the controller 18 and is used if, for example, a stern drive is hinged up or other technical means are in the way, the folding frame 1 cannot be lowered accordingly, or if the folding frame 1 is already hinged up in position D, the stern drive cannot be raised until the folding frame 1 is accordingly out of the way and thus a collision is avoided. This is solved by one or more sensors, such as e.g. inductive, infrared or ultrasound e.g. sensors. The controller 18 can also emit acoustic or visual signals.

FIG. 2 shows a diagrammatic side view of a swiveling folding frame 1 with adjustable step mean 16 to which rail elements 21 are attached. The swiveling means 2, which is located in a housing, not shown here, is attached to a displacement plate 22 to which guide cams 23 are fastened, which engage in a guide groove 24, which are embedded in the swivel plate 25. The swivel plate 25 is carried by a lockable lift means 26, composed of two arms 26a, 26b, in the form of a parallelogram and mounted accordingly on the stern 27 of the watercraft. The position of the lockable lift means 26 is held or changed by means of the cylinder 28 according to arrow H. The cylinder 28 is responsible for the locking of the lift means 26, by means of an electric or hydraulic locking valve 69 on a hydraulic cylinder or a locking means on an electric cylinder, which can be a self-locking spindle and or a brake on the electric motor of the cylinder 28 or a separate locking. A displacement cylinder 29 is attached to the swivel plate 25, which displacement cylinder is connected to the displacement plate 22. Furthermore, a platform 30 is attached to the stern 27, which platform has a stern rail 31, which e.g. extends from the vehicle garage via the stern 27 to the platform 30. A sub-platform 32, which has a rail section 33, is located below the platform 30. The unfolding of the folding frame 1 in the first phase extends only up to the horizontal position C, in that a further unfolding is prevented by means of the retaining means 34. The retaining means 34 monitors the rail block 59 and depends among other things on the signal of the tender sensor 60 or on the operator of the system.

This system is designed for raising tenders from water or lowering tenders into water. If a tender is located in the garage or on the platform 30 on a displaceable, rail-linked conveyance, the folding frame 1 can be unfolded up to position C and is stopped by the retaining means 34 at this point so that the folding frame 1 is positioned parallel to the platform 30. Furthermore, the retaining means 34 takes over the load of the tender with moving over the folding frame 1 and to this end can unload the locking means 10 or the transmission 5, which e.g. is designed only for the static load of persons. Additionally rail elements 21 are attached to the step means 16 or to the folding frame 1 or to additional support means. The rail elements 21 and possibly the rail section 33 on the displacement plate 22 extended by means of the cylinder 29, are aligned with the alignment sensor 58 and the associated software accordingly to the stern rail 31 by means of the cylinder 28 with respect to leveling and displacement cylinder 29 with respect to the gap width, so that the tender can be shifted easily when required by means of the conveyance from the stern rail 31 to the rail section 33 and further onto the rail elements 21. The rail elements 21, stern rail 31 and rail section 33 have a claw shape that prevents the conveyance from jumping out. Depending on the tender dimension, it may not be possible to lower the tender by means of the lockable lift means 26 due to the folding frame 1 projecting to a limited extend and the tender would therefore collide with the platform 30. Here the folding frame 1 can be shifted further backwards according to arrow R by means of the displacement plate 22 and activation of the displacement cylinder 29, so that the tender can be lowered into the water without touching the platform 30. The sub-platform 32 furthermore serves as a possible extension of the platform 30 so that the gap between the platform 30 and the folding frame 1 is elegantly covered. When the blockable lift means 26 is lifted by means of the cylinder 28, furthermore a single plane can be generated behind the transom 27 of the watercraft. If the tender is in the water and the conveyance which takes the tender on board has been guided back again, detected by means of the tender sensor 60, e.g. in the from of a proximity switch, the retaining means 34, which can be a bolt or a pivoting carrier part, can be released and the folding frame 1 can be unfolded further up to position D and, due to the retention of the step means 16, which are designed as adjustable step elements, represent convenient stairs to or into the water. The tender function is secured in the form of a rail block 59, e.g. in the form of a lifting magnet with a bolt that blocks the path of the conveyance, if at the same time the folding frame 1 has not been released in the desired position, i.e. by the alignment sensor 58, and the retaining means 34 not activated. Likewise, the retaining means 34 cannot be released until the tender sensor 60 emits a positive signal to the controller 18. The conveyance furthermore can likewise be loaded by means of a mechanical locking mean if one of the attributes for free movement on the folding frame 1 is not met.

Of course, in this structural embodiment the folding frame 1 in the position Y can also serve as cockpit cover or in position B as a gangway.

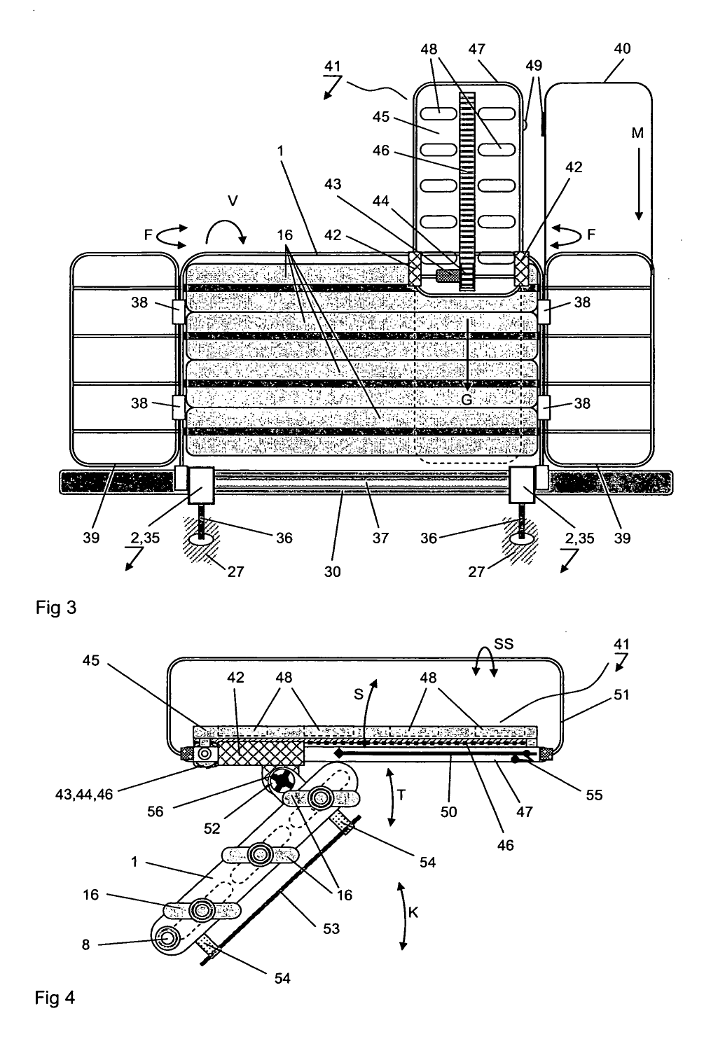

FIG. 3 shows a diagrammatic stern view of a swiveling folding frame 1, which represents a U-shape and advantageously is composed of a homogenous round or oval pipe, which is correspondingly curved and thus ensures a high stiffness without weld seams, or in exceptional cases an angular pipe, which is screwed or welded such that in this manner likewise a high torsional stiffness of the folding frame 1 is given, with adjustable step means 16 attached thereto according to arrow V, wherein the folding frame 1 is attached to the housing 35 by means of the swiveling means 2 and the housing 35 is mounted on the platform 30 and is supported by means of the supports 36 on the stern 27. The swiveling means 2 are connected to one another in a torsionally stiff manner by means of the synchronous pipe 37. If the pivoting means 2 are equipped with a displacement measuring system, a synchronous pipe 37 is not necessary on the two sides of the folding frame 1 to synchronize the drives, but this would have negative consequences in the case of a failure of a motor 4 or of a hydraulic cylinder 62, as described in FIG. 5. Two rotating folding frames 39 are attached to the folding frame 1 by means of hinges 38, one of which rotating folding frames has an extendable handrail 40, according to arrow M. Furthermore, an extendable gangway 41 is attached to the folding frame 1, which gangway is guided on two guide pipes 42, and actuated by means of a drive motor 43 and a pinion 44, acts on a toothed rack 46 mounted on the gangway plate 45 according to arrow G.

The additional function on the folding frame 1 includes a telescoping gangway 41, which can be extended by means of a rack drive 43, 44, 46 and based on the guide pipes 42 and is extremely compact in construction. The gangway frame 47 engages in the guide pipes 42, which are responsible for the longitudinal guidance, and the gangway plate 45 mounted on the gangway frame 47 thereby carries the rack 46. The gangway plate 45 can be walked on and has integrated steps 48 in order to make it possible for the passengers on board to reach the shore more easily and conveniently in the case of larger differences in height between the vehicle and the pier or harbor jetty, etc. by using the steps 48, but also in the step position, the gangway 41 thereby serves as an extended step means and the integrated steps 48 can be used as stair steps.

Furthermore, a rotating folding frame 39 can be attached to the folding frame 1 by means of hinges 38 on each side and in this manner e.g. a wide cockpit cover or an extremely generous platform can be produced on the craft stern, and by means of the possibility of angling of the rotating folding frame 39 by 90° according to arrow F at the same time form a stable handrail function. The rotating folding frame 39 is thereby held in the corresponding offset by means not indicated here. Furthermore, it is conceivable that a corresponding guide is integrated in the rotating folding frame 39 so that an additional handrail 40 can be extended therefrom and by means of a connecting element 49 the gangway 41 and the extended handrail 40 are chained to one another and renders possible an increased stability of the handrail 40. Of course, further gangways 41 in a telescoping form can be guided into and extended out of one another.

It is furthermore an additional advantage if the folding frame 1 stands sturdily on the platform 30, not only in optical terms, but also with regard to torsional stiffness and therefore the folding frame 1 is ideally wider than it is high. The height can be best solved separately by means of the above-mentioned gangway 41. The rotating folding frames 39 can be outside or inside the folding frame 1 and the folding frame 1 can again be pivoted externally, i.e., represent a 4-point bearing on the platform 30.

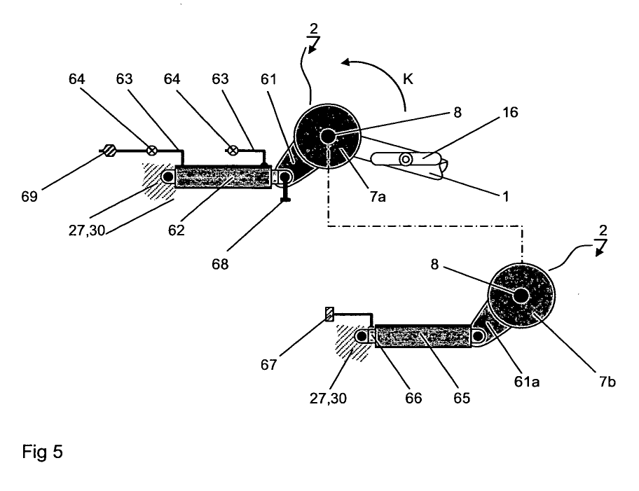

FIG. 4 shows a diagrammatic side view of an extendible gangway 41 with two different operable, extendible stanchions 50 or retaining brackets 51 as well as by means of an adjustment angle means 52, the gangway 41 can be pivoted with respect to the folding frame 1 and a cover 53, which is attached with spacers 54 to the folding frame 1.

The unfolding of a stanchion 50 on a gangway 41 according to arrow S is not new per se, but the stanchion locking 55 without rope tension is not thus known and also makes it possible on the opposite site and on the opposite end of the gangway 41 to use an identical stanchion 50, which for the user of the gangway 41 represents a safe hold when crossing the gangway 41. An even more elegant variant is the laterally unfoldable retaining bracket 51, which in the idle condition lies over the gangway 41 and before extension is first pivoted up according to arrow SS and likewise as with the stanchion 50 is correspondingly locked. The gangway 41 thus ultimately has an extremely convenient handrail for crossing it. The extremely compact drive unit, by means of a rack drive 43, 44, 46 in order to thus shift the gangway 41, was described in FIG. 3. In addition there is the easy handling by means of an adjustment angle means 52 of adjusting the gangway 41 accordingly in angle after the folding frame 1 has been folded accordingly. This takes place manually by means of a tooth flank disk, which is tightened by means of a locking screw 56 and the angular position is thus maintained. Furthermore, the gangway 41 has a defined stop point for the maximum adjustment angle, so that the gangway 41 can never tilt away forwards. Instead of a manual adjustment and locking, this can also be realized by means of a simple electric drive with brake or latching and the entire gangway unit can also be offered as a standalone on watercraft, due to the very compact drive technology and kinematics.

An additional property of the system is, in particular position Y or A of the folding frame 1, as shown in FIG. 2, namely the possibility of adjusting the step means 16 such that in the stern region it is possible to see the sea or in the case of wind and waves the stern region can be closed immediately. A corresponding cover 53 ideally combines these two possibilities in one, in that a transparent cover 53 is attached by means of spacers 54 to the folding frame 1 so that the step means 16 can rotate freely as adjustable step elements without colliding with the cover 53. Wind and waves are thus kept out of the interior of a watercraft, but the view is retained or can nevertheless be closed at any time in order to block the view into the cockpit of the yacht. When the folding frame 1 is unfolded, the step elements are adjusted with it in order to retain their horizontal position, with the possibility the folding frame 1 in position B in the “gangway” mode of being able to extend the optional telescoping gangway 41 or to fold it in position C as “platform” mode or in position D as “stair” mode, wherein the cover 53 is folded with it but remains untouched with the exception that it becomes wet. The cover 53 can be illuminated accordingly, likewise differently transparent and colored films, as well as structures can be used on the cover or as a laminate between the transparent materials and bring out different special points on the stern of the watercraft.

FIG. 5 shows a diagrammatic side view of a double pivoting means 2 with a turntable 7a attached to the same slewing journal 8 with a pivoted lever 61 on which a hydraulic cylinder 62 acts, which is supported on the stern 27 or platform 30 and the hydraulic cylinder 62 has at least one fluid hose 63, on which a pressureless switch 64 is located, as well as a stop valve 69 and the turntable 7a accommodates the folding frame 1, and the turntable 7b with a pivoted lever 61a is located on the same slewing journal 8, a lockable gas spring 65 acts thereon, which is supported on the stern 27 or platform 30 and on the gas spring piston rod 66 thereof an unlockable valve 67 is mounted.

Hydraulic cylinders 62 are simple active cylinders which with little expenditure can generate high forces and are also suitable for a swiveling folding frame 1, which stands in place of a railing, but have the disadvantage that in the event of a failure of the hydraulic system and if people are located on the step means 16, this can lead to further problems. Although there are various hydraulic breakage safeguards, shown here as stop valve 69, which are better than nothing, unfortunately, these rarely remain tight over time and an unattractive tilting of the overall system can still result. In the event that the folding frame 1 has been pivoted completely downwards and the hydraulic system fails, this can hardly be moved with the weight of the step means 16 and with the hydraulic oil possibly blocked in the hydraulic cylinder 62. The inventive step is to switch the hydraulic cylinder 62 in a pressureless manner, in that pressureless switches 64 are located on the fluid hose 63, which e.g. can be switched manually by means not shown here and make the hydraulic system pressureless, furthermore that the hydraulic oil with actuation of the hydraulic cylinder 62 or indirectly of the folding frame 1 or the turntable 7, 7a, 7b can flow into the tank with as little resistance as possible and no vacuum can form in the second chamber of the hydraulic cylinder 62. At the same time, with the means that actuates the pressureless switch 64, the unlocking valve 67, which is located on the gas spring piston rod 66 of the lockable gas spring 65, can be opened. The lockable gas spring 65 is attached to the stern 27 or platform 30 and acts on the pivoted lever 61a and moves it such that the turntable 7b or the slewing journal 8 performs a rotation and raises the folding frame 1, according to arrow K.

The gas spring 65 can be a gas pressure or gas tension spring and can be permanently pressure-acting or tension-acting or lockable in a desired position.

In order to save additional costs, but not to reduce safety, a gas spring 65 without locking and unlocking valve 67 can be mounted, so that in the event of a loss of pressure in the hydraulic cylinder 62, the folding frame 1, in the event that it has been swiveled forwards in advance, moves gently upwards a little until the vacuum in the closed hydraulic cylinder 62 stops the lifting operation in the arrow direction K until finally the pressureless switch 62 is deliberately actuated and the folding frame 1 is deliberately raised and by means of the pressure in the gas spring 65, this remains held in the end position.

Naturally, the turntable 7a, 7b can be one-piece, likewise the pivoted lever 61, 61a and the hydraulic cylinder 62 thus act on one side of the turntable 7a, 7b and the gas spring 65 on the opposite side. A quick release means 68 is used so that e.g. instead of the pressureless switch 64 this can be quickly and easily released so that the attachment of the hydraulic cylinder 62 is released from the turntable 7a, 7b and the gas spring 65 can thus act freely.

Of course, the invention is not limited only to the exemplary embodiments shown and described.

List of reference numbers

| | |
|---|---|
| 1 | Folding frame |
| 2 | Swiveling means |
| 3 | Rotation active means |
| 4 | Motor |
| 5 | Transmission |
| 6 | Gear wheel |
| 7, 7a, 7b | Turntable |
| 8 | Slewing journal |
| 9 | Blocking recess |
| 10 | Blocking means |
| 11 | Angular sensor |
| 12 | Freewheel mechanism |
| 13 | Damping |
| 14 | Traction means |
| 15 | Helical tension spring |
| 16 | Step means |
| 17 | Bearing |
| 18 | Controller |
| 19 | Button |
| 20 | Incidence of light sensor |
| 21 | Rail element |
| 22 | Displacement plate |
| 23 | Guide cams |
| 24 | Guide groove |
| 25 | Swivel plate |
| 26 | Lifting means |
| 26a, 26b | Arm |
| 27 | Stern |
| 28 | Cylinder |
| 29 | Displacement cylinder |
| 30 | Platform |
| 31 | Stern rail |
| 32 | Sub-platform |
| 33 | Rail section |
| 34 | Retaining means |
| 35 | Housing |
| 36 | Support |
| 37 | Synchronous pipe |
| 38 | Hinge |
| 39 | Rotating folding frame |
| 40 | Handrail |
| 41 | Gangway |
| 42 | Guide pipe |
| 43 | Drive motor |
| 44 | Pinion |
| 45 | Gangway plate |
| 46 | Rack |
| 47 | Gangway frame |
| 48 | Step |
| 49 | Connecting element |
| 50 | Stanchion |
| 51 | Retaining bracket |
| 52 | Adjustment angle means |
| 53 | Cover |
| 54 | Spacer |
| 55 | Stanchion lock |
| 56 | Locking screw |
| 57 | Collision sensor |
| 58 | Alignment sensor |
| 59 | Rail block |
| 60 | Tender sensor |
| 61 | Pivoted lever |
| 62 | Hydraulic cylinder |
| 63 | Fluid hose |
| 64 | Pressureless switch |
| 65 | Gas spring |
| 66 | Gas spring piston rod |
| 67 | Lockable valve |
| 68 | Quick release means |
| 69 | Stop valve |
| F | Offset rotating folding frame 39 |
| G | Travel gangway 41 |
| H | Stroke lifting means 26 |
| K | Folding path swivel frame 1 |
| M | Expel path handrail 40 |
| R | Stroke displacement plate 22 |
| S | Folding path stanchion 50 |
| SS | Folding path retaining bracket 51 |
| T | Tilt gangway 41 |
| V | Adjustment step means 16 |

1. A folding frame (1) characterized in that the folding frame (1) has a swiveling means (2) with a locking means (10) mechanically engaging thereon or a stop valve (69) and/or a gas spring (65) and adjustable step means (16) and is attached to a platform (30) or that the folding frame (1) has a swiveling means (2) with a locking means (10) mechanically engaging thereon or a stop valve (69) and/or a gas spring (65) and adjustable step means (16) and a lockable lifting means (26) and is fastened to a platform (30).

2. The folding frame (1) according to claim 1, characterized in that the folding frame (1) is a circumferential, torsionally stiff, U-shaped formation and represents a railing and this can be tubular round or oval or angular.

3. The folding frame (1) according to claim 1, characterized in that the hydraulic cylinder (62) has a pressureless switch (64) or a quick release means (68), the gas spring (65) is permanently pressure-acting or tension-acting or lockable is.

4. The folding frame (1) according to claim 1, characterized in that the swiveling means (2) has a rotation active means (3) with a locking means (10) and that the swiveling means (2) is attached to the stern (27) or to the platform (30) or that the swiveling means (2) has a rotation active means (3) with a locking means (10) and is attached to the locking lifting means (26) by means of a swivel plate (25) or a swivel plate (25) and a displacement plate (22) and a retaining means (34) is attached to one of the two and the lifting means (26) is attached to the stern (27) or to the platform (30).

5. The folding frame (1) according to claim 2, characterized in that a guide groove (24) and a displacement cylinder (29) are attached to the swivel plate (25) and the displacement plate (22) is mounted thereon in a displaceable manner by means of the guide cam (23) and the displacement cylinder (29) engages on the displacement plate (22) and the swiveling means (2) and the retaining means (34) are attached to the swivel plate (25).

6. The folding frame (1) according to claim 1, characterized in that the locking means (10) engages in a blocking recess (9), which is located on the turntable (7) or the turntable (7) has a self-locking spindle on the transmission (5) and the turntable (7) supported on a slewing journal (8) is accommodated in a waterproof housing (35) and the turntable (7) is connected to a gear wheel (6), which engages in a transmission (5) and this is driven by a motor (4) and the turntable (7) has a damping (13) which is connected to the folding frame (1) directly or indirectly by means of a freewheel mechanism (12).

7. The folding frame (1) according to claim 1, characterized in that a traction means (14) is attached to the turntable (7), on which traction means a helical tension spring (15) is located and the helical tension spring (15) can be a mechanical spring or a lockable gas spring (65) and/or the folding path K of the folding frame (1) is greater than 120°.

8. The folding frame (1) according to claim 1, characterized in that the folding path (K) is detected by means of an angular sensor (11) and the controller (18) is responsible for whether a command is triggered on the button (19), which tests attributes in advance and triggers according to the algorithm and contains attributes the speed of the propeller and or the position of the stern drive and or position of the tender vehicle and for this purpose the collision sensor (57), alignment sensor (58) and or tender sensor (60) and or motor speed sensor and or transmission sensor, provide the sensor signals to the controller (18) and accordingly also can emit acoustic or visual signals.

9. The folding frame (1) according to claim 1, characterized in that the rail block (59) is independent of the tender sensor (60) and or alignment sensor (58) and or retaining means (34) and the alignment sensor (58) is responsible for the leveling and gap width between the platform (30) and displacement plate (22) or sub-platform (32) or swivel plate (25).

10. The folding frame (1) according to claim 1, characterized in that the leveling is carried out by means of the cylinder (28) and the gap width by means of the displacement cylinder (29).

11. The folding frame (1) according to claim 1, characterized in that the folding frame (1) has adjustable step means (16), which are adjustable force controlled or independent of the folding path (K) and or the folding frame (1) has a cover (53), which leaves the step means (16) adjustment space and the cover (53) and or the step means (16) are transparent and can be dyed in colors and or have structures.

12. The folding frame (1) according to claim 1, characterized in that the folding frame (1) or a separate support means or the step means (16) have rail elements (21), the stern (27) and the platform (30) have a stern rail (31), the sub-platform (32) has a rail section (33), which have a form that allow a conveyance to move thereon but cannot allow it to jump out of the form and/or that the step means (16) have solar panels and by means of the incidence of light sensor (20) and the controller (18) the step means (16) track the maximum incidence of light.

13. The folding frame (1) according to claim 10, characterized in that the folding frame (1) has a rotating folding frame (39) with hinges (38) and or a gangway (41) and/or the rotating folding frame (39) has a handrail (40) and/or the gangway (41) can be extended manually or by means of a drive motor (43) and a pinion (44) and a rack (46), guided by means of a guide pipe (42) on a gangway frame (47) to which a gangway plate (45) is attached optionally with steps (48) and can optionally contain a connecting element (49) and/or the gangway (41) can also be used as a step means.

14. The folding frame (1) according to claim 1, characterized in that the gangway (41) can be tilted by means of the adjustment angle means (52) manually or in a powered manner via the tilt path (T) and can be locked in each position by means of the locking screw (54) and the gangway (41) has a lockable stanchion (50) or a lockable retaining bracket (51).

15. The folding frame (1) according to claim 1, characterized in that the cylinder (28), displacement cylinder (29), drive motor (43) are lockable and are operated hydraulically or electrically and the rotation active means (3) is operated hydraulically or electrically.

16. The folding frame (1) according to claim 1, characterized in that the folding frame (1) is wider than it is high.
